(19) United States
(12) Patent Application Publication
(10) Pub. No.: US 2009/0001746 A1
(43) Pub. Date: Jan. 1, 2009

(54) LID FOR VEHICLE CARGO BIN

(76) Inventors: William Karagitz, Royal Oak, MI (US); D. Scott Bittinger, Fenton, MI (US); Shawn R. Williams, Auburn Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/771,058

(22) Filed: Jun. 29, 2007

(51) Int. Cl. B60R 7/04

(52) U.S. Cl. 296/37.8; 220/737

(57) ABSTRACT

A cargo bin comprising a housing having a pair of mounting brackets. A J-shaped slot is formed in each mounting bracket, and a lid that includes a pair of pins slidably mounted in the J-shaped slots is attached to the housing. The lid includes pair of notched portions that are formed in the lid and correspond to the mounting brackets. The lid is actuatable between an open position and a closed position by sliding the pins through the J-shaped slots. To assist in supporting the lid when the lid is open, a surface that defines the notched portion rests on the mounting brackets.

### FIELD

The present invention relates to a cargo bin for a motor vehicle.

### BACKGROUND

Motor vehicles may include cargo bins for stowing various articles. These cargo bins, however, may include a lid that is not supported. Opening the cargo bin and removing articles therefrom, therefore, may be difficult as a user is required to use one hand to hold the lid open while using another hand to remove articles. Furthermore, if the cargo bin includes a system that supports the lid in an open position, these systems are expensive to produce and also prevent the lid from being removed from the cargo bin easily.

### SUMMARY

A cargo bin includes a housing having a pair of mounting brackets. A J-shaped slot is formed in each mounting bracket, and a lid that includes a pair of pins slidably mounted in the J-shaped slots is attached to the housing. The lid includes pair of notched portions that are formed in the lid and correspond to the mounting brackets. The lid is actuatable between an open position and a closed position by sliding the pins through the J-shaped slots. To assist in supporting the lid when the lid is open, a surface that defines the notched portion rests on the mounting brackets.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

The present teachings will become more fully understood from the detailed description and the accompanying drawings, wherein:

FIG. 1 is a perspective view of a cargo bin according to the present teachings;

FIG. 2 is a perspective view of a cargo bin according to the present teachings with the lid inverted;

FIG. 3 is a cross-sectional view of a cargo bin according to the present teachings integrated with a motor vehicle;

FIG. 4 is a cross-sectional view illustrating connection between a cargo bin according to the present teachings and a lid;

FIG. 5 is a partial exploded perspective view illustrating connection between a cargo bin according to the present teachings and a lid; and

FIG. 6 is a partial perspective view illustrating a fastener that may be used to secure a cargo bin according to the present teachings to a motor vehicle.

### DETAILED DESCRIPTION

The following description is merely exemplary in nature and is in no way intended to limit the present teachings, their application, or uses.

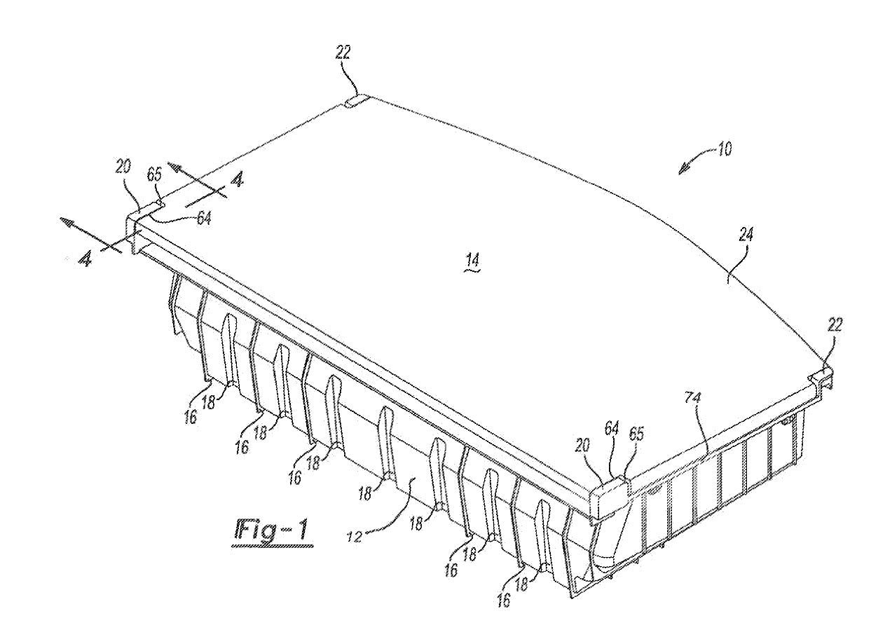

FIGS. 1 to 3 illustrate a cargo bin 10 according to the present teachings. Cargo bin generally includes a tub or housing 12 and a lid 14. Housing 12 and lid 14 may be formed of a blow molded plastic. The shape and contours of housing 12 and lid 14, therefore, may be selected according to configuration desires by one skilled in the art.

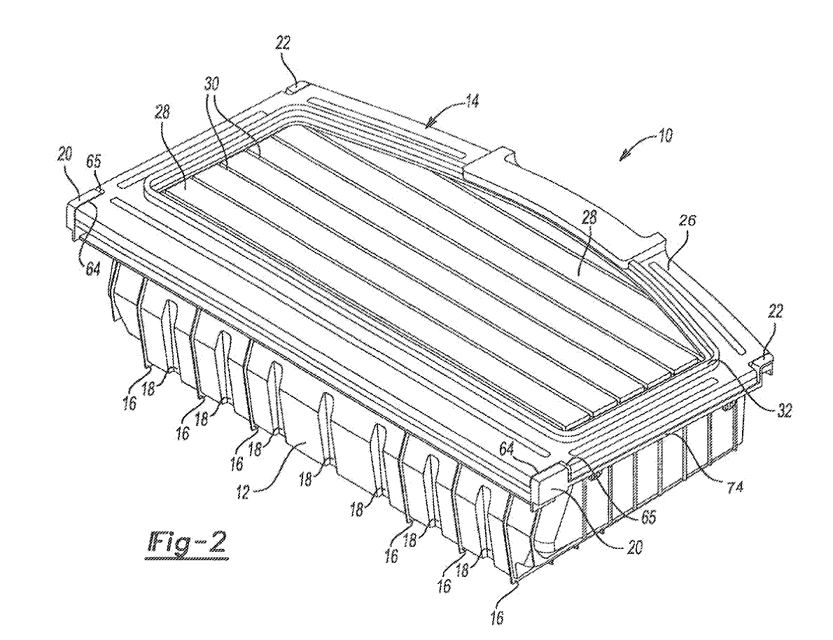

In FIGS. 1 and 2, housing 12 may include a plurality of ridges 16 and recesses 18. Ridges 16 and recesses 18 provide structural rigidity to housing 12, and may also correspond to ridges and recesses (not shown) where cargo bin 10 is to be mounted. Housing 12 may also include integral mounting brackets 20 for attaching lid 14 thereto, as well as alignment tabs 22. Alignment tabs 22 assist in preventing movement of lid 14 when lid 14 is in a closed position relative to housing 12.

Lid 14 may be a reversible lid that may include a generally a smooth surface 24 (FIG. 1) and a grooved surface 26 (FIG. 2). Smooth surface 24 enables various cargo items to be stored thereon and easily removed therefrom by sliding and the like. In contrast, lid 14 may be reversed to expose grooved surface 26 that may include a plurality of lands 28 separated by grooves 30.

Surrounding lands 28 and grooves 30 may be a retaining wall 32. Grooved surface 26 increases the functionality of cargo bin 10 in that cargo that is wet or dirty may be disposed thereon. Dirt and water may then drain into grooves 30 and be prevented from dirtying the area where cargo bin 10 is disposed. Grooved surface 26 may also provide a surface with increased friction that may assist in preventing cargo disposed thereon from moving and shifting during operation of the motor vehicle.

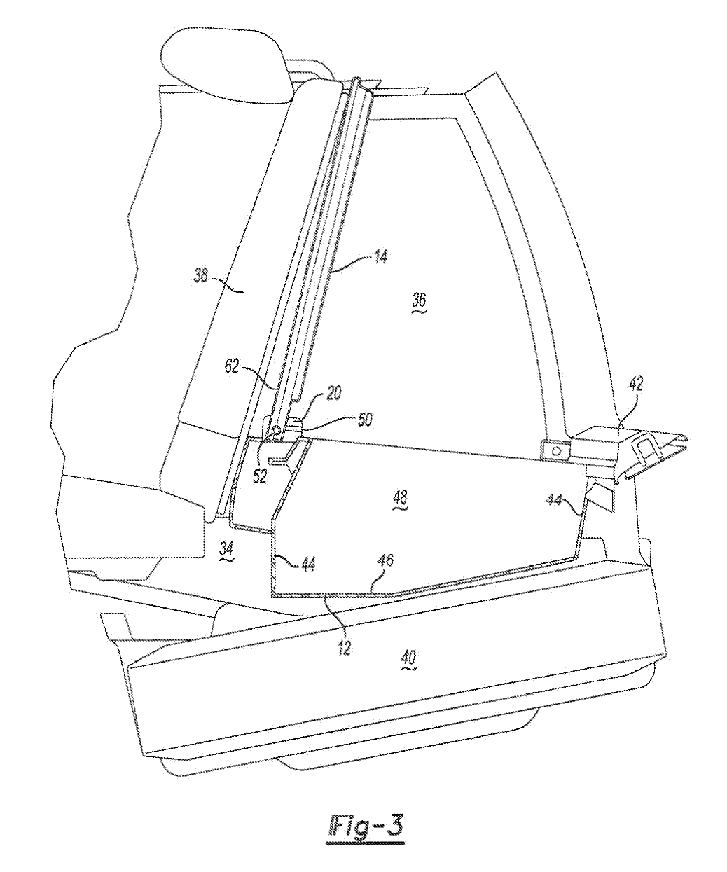

As illustrated in FIG. 3, cargo bin 10 generally may be disposed within a recess 34 in a cargo area 36 of a motor vehicle that may be defined by a rear seat 38, a tire carrier 40 mounted underneath the motor vehicle, and a mounting surface 42 for a rear hatch or tail gate. By disposing cargo bin 10 in recess 34, lid 14 may form a surface that is essentially co-planer with a floor surface of cargo area 36 when lid 14 is in a closed position. Sidewalls 44 and a bottom surface 46 of cargo bin 10 define an interior volume 48 that may have dimensions that fill the entire cargo area 36.

Alternatively cargo bin 10 may have an interior volume 48 with dimensions that are smaller than cargo area 36. Regardless, the dimensions of cargo bin 10 may be selected such that cargo bin 10 may be adapted for use in any size cargo area of a motor vehicle. Furthermore, although sidewalls 44 and bottom surface 46 of cargo bin 10 are shown to be slightly angled to adapt cargo bin 10 for mounting in recess 34 the present teachings should not be limited thereto. In contrast, sidewalls 44 and bottom surface 46 may be oriented in any manner to adapt cargo bin 10 for use in any type of motor vehicle.

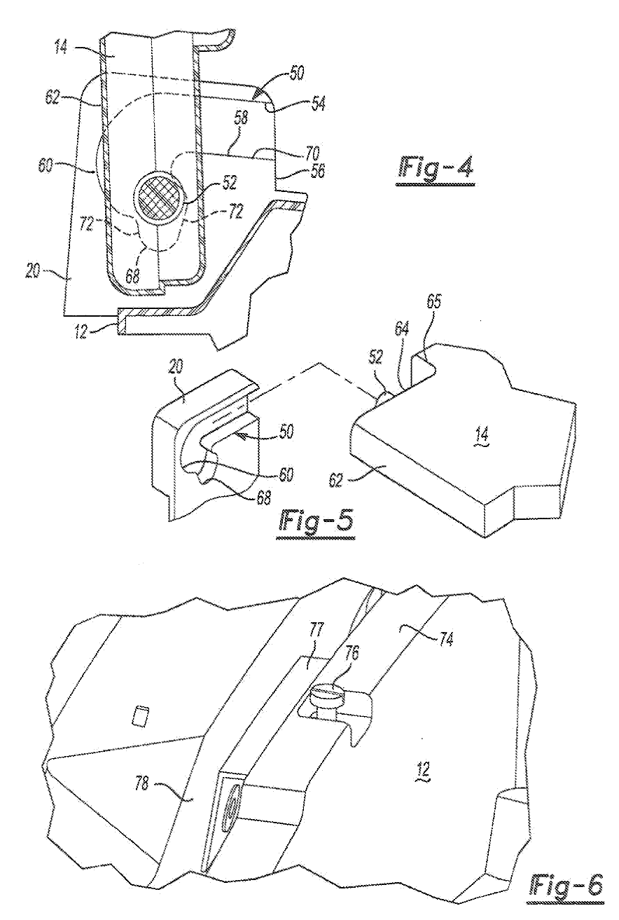

In FIGS. 4 and 5, mounting bracket 20 of housing 12 includes a slot 50 that accommodates a prong or pivot pin 52 that may be formed on lid 14. Slot 50 may be hook- or J-shaped, and an end 54 of J-shaped slot 50 is open at an edge 56 of mounting bracket 20 such that pin 52 may be removed from J-shaped slot 50. In this manner, lid 14 is removable from housing 12 and, as stated above, reversible.

An inner surface 58 of J-shaped slot 50 provides a bearing surface for pin 52 that enables pin 52 to slide and pivot thereon. J-shaped slot 50 may be shaped so that when lid 14 is opened, pin 52 slides along inner surface 58 in a direction toward a curved portion 60 of J-shaped slot 50. Once pin 52 reaches curved portion 60, pin 52 may sit within curved portion 60 and sustain lid 14 in an upright position.

The configuration of J-shaped slot 50 allows lid 14 to be opened and stationed in a plurality of positions. For example, again referring to FIG. 3, lid 14 of cargo bin 10 may be slightly angled relative normal to accommodate seat 38 when seat 38 is in an upright position. Lid 14 may be angled relative normal when pin 52 sits within curved portion 60 of J-shaped slot 50. In addition, to assist in supporting lid 14 in an open position, an end 62 of lid 14 that includes pins 52 includes notch portions 64. Notch portions 64 have a size that corresponds to mounting brackets 20 when lid 14 is closed. Pins 52 may be formed in notch portions 64, and when lid 14 is in an open position, a surface 65 that defines notch portion 64 may rest on mounting bracket 20 to support lid 14 thereon. In this manner, lid 14 may be supported in an open position such that a user may freely remove cargo from the cargo bin 10 without using a hand or device to prop open the lid 14.

In FIG. 4, lid 14 may be oriented to a position that is substantially normal to housing 12. To allow lid 14 to be oriented substantially normal to housing 12, J-shaped slot 50 may further include a recess 68 that extends outward from curved portion 60 in a direction substantially perpendicular to a leg portion 70 of J-shaped slot 50. Recess 68 may be defined by surfaces 72 that allow pin 52 to sit therein.

In FIG. 6, to secure cargo bin 10 to the motor vehicle, housing 12 may be provided with a flange 74 that extends around a perimeter of housing 12. Fasteners 76 may be used to secure flange 74 to a bracket 77 formed on a floor 78 of the vehicle. Although fasteners 76 are shown, it should be understood that cargo bin 10, as stated above, may also be formed to include ridges 16 and recesses 18 that may correspond to additional ridges and recesses (not shown) that are formed in the recess 34 of the vehicle cargo area 36. Accordingly, fasteners 76 are not necessarily required by the present teachings and may be omitted.

The above description is merely exemplary in nature and, thus, variations that do not depart from the gist of the present teachings are intended to be within the scope of the present teachings. Such variations are not to be regarded as a departure from the spirit and scope of the present teachings.

What is claimed is:

1. A cargo bin comprising:
a housing;
a mounting bracket having a J-shaped slot integral with said housing; and
a lid having a pin mounted to said bracket, said pin corresponding to said slot;
wherein said lid is actuatable between an open position and a closed position, said pin being movable through said J-shaped slot to support said lid in said open position.

2. The cargo bin of claim 1, wherein said lid is reversible.

3. The cargo bin of claim 2, wherein a first surface of said lid is smooth and a second surface of said lid is grooved.

4. The cargo bin of claim 1, wherein said lid includes a notched portion, said pin formed in said notch portion.

5. The cargo bin of claim 1, wherein said J-shaped slot includes a curved portion, said pin resting in said curved portion when said lid is in said open position.

6. The cargo bin of claim 5, wherein said J-shaped slot includes a recess extending outward from said curved portion, said pin resting in said recess when said lid in said open position.

7. The cargo bin of claim 1, wherein a surface of said notched portion rests on said mounting bracket when said lid is in said open position.

8. The cargo bin of claim 1, wherein said housing and said lid are formed from blow-molded plastic.

9. A cargo bin comprising:
a housing having a pair of mounting brackets;
a J-shaped slot formed in each mounting bracket;
a lid having a pair of pins that are slidably mounted in said J-shaped slots;
a pair of notched portions formed in said lid that correspond to said mounting brackets,
wherein said lid is actuatable between an open position and a closed position by sliding said pins through said J-shaped slots, and a surface that defines said notched portion resting on said mounting bracket when said lid is in said open position.

10. The cargo bin of claim 9, wherein said lid is reversible.

11. The cargo bin of claim 10, wherein a first surface of said lid is smooth and a second surface of said lid is grooved.

12. The cargo bin of claim 9, wherein said pins are formed in said notch portions.

13. The cargo bin of claim 9, wherein said J-shaped slots include a curved portion, said pins resting in said curved portions when said lid is in said open position.

14. The cargo bin of claim 13, wherein said J-shaped slots include a recess extending outward from said curved portion, said pin resting in said recess when said lid in said open position.

15. The cargo bin of claim 9, wherein said housing and said lid are formed from blow-molded plastic.

16. A cargo bin for integration with a floor of a motor vehicle, comprising:
a housing disposed in the floor of the motor vehicle, said housing having a pair of mounting brackets;
a J-shaped slot formed in each mounting bracket;
a lid having a pair of pins that are slidably mounted in said J-shaped slots;
a pair of notched portions formed in said lid that correspond to said mounting brackets,
wherein said lid is actuatable between an open position and a closed position by sliding said pins through said J-shaped slots, said lid being essentially co-planar with the floor of the motor vehicle when said lid is in said closed position, and a surface that defines said notched portion resting on said mounting bracket when said lid is in said open position.

17. The cargo bin of claim 16, wherein said lid is reversible.

18. The cargo bin of claim 16, wherein said pins are formed in said notch portions.

19. The cargo bin of claim 16, wherein said J-shaped slots include a curved portion, said pins resting in said curved portions when said lid is in said open position.

20. The cargo bin of claim 19, wherein said J-shaped slots include a recess extending outward from said curved portion, said pin resting in said recess when said lid in said open position.
